(19) United States
(12) Patent Application Publication
(10) Pub. No.: US 2010/0023394 A1
(43) Pub. Date: Jan. 28, 2010

(54) Method, System And Server For Delivering Advertisement Based on User Characteristic Information

(75) Inventors: Yading YUE, Shenzhen City (CN); Huanhua LIAO, Shenzhen City (CN); Dake SONG, Shenzhen City (CN); Yihui LIU, Shenzhen City (CN); Lei GONG, Shenzhen City (CN); Haitao ZENG, Shenzhen City (CN); Xiaoguang WU, Shenzhen City (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED, Shenzhen City (CN)

(21) Appl. No.: 12/572,328

(22) Filed: Oct. 2, 2009

Related U.S. Application Data
(63) Continuation of application No. PCT/CN2008/070468, filed on Mar. 11, 2008.

(30) Foreign Application Priority Data
Apr. 11, 2007 (CN) 200710100736.6

(51) Int. Cl. G06Q 30/00

(52) U.S. Cl. 705/14.43; 705/14.66

(57) ABSTRACT

Embodiments of the present invention provide a method, system and server for delivering an advertisement based on user characteristic information. The method includes performing, by a server, data mining on user raw data corresponding to a client to obtain user characteristic information, generating a characteristic label based on the user characteristic information; determining, by the server, a type of advertisement according to the characteristic label, and delivering an advertisement of the type to the client. In the embodiments of the present invention, a great amount of user raw data is collected and stored in a server, data mining is performed on the user raw data, a characteristic label is generated based on user characteristic information obtained, and a network advertisement is delivered according to the characteristic label. Therefore, the advertisement can be delivered to particular users and the click ratio of the advertisement is increased.

### CROSS-REFERENCE TO RELATED APPLICATIONS

This application is a continuation of International Application No. PCT/CN2008/070468, filed Mar. 11, 2008. This application claims the benefit and priority of Chinese Application No. 200710100736.6, filed Apr. 11, 2007. The entire disclosure of each of the above applications is incorporated herein by reference.

### FIELD

The present disclosure relates to telecommunication technologies, and more particularly, to a method, system and server for delivering an advertisement based on user characteristic information.

### BACKGROUND

This section provides background information related to the present disclosure which is not necessarily prior art.

In current communication-dominant economic society, with developments of Internet technologies, network intelligent advertisement technique is developing quickly.

The core part of the network intelligent advertisement technique includes audience analysis technique. The audience analysis technique means analyzing online behaviors of an Internet user to obtain user characteristic information, such as age, gender, geographical location, income, interests of the user, and so on, so as to deliver to the user a particular advertisement in which the user is interested.

At present, the most widely-applied audience analysis technique includes collecting user registration information as the user characteristic information and delivering an advertisement according to the user characteristic information. FIG. 1 illustrates a structure of a system for delivering an advertisement according to the prior art. The system includes server 100, and a plurality of clients connecting with the server 100, i.e. client 200, client 300 . . . client N. The server 100 includes database 101 and advertisement delivering unit 103.

(1) The database 101 is adapted to store user raw data collected. The user raw data mainly includes registration information submitted by the user to the network, such as a website and a forum etc.

(2) The advertisement delivering unit 103 is adapted to determine a type of advertisements based on the user registration information collected in the database 101, and deliver an advertisement of this type to each client, i.e. client 200 . . . client N.

It can be seen that, the above conventional scheme does not mine the user raw data deeply enough, and thus precise user characteristic information can not be obtained. Therefore, the advertisement can not be delivered to particular users, and further the hit ratio i.e. click ratio of the advertisement is low.

### SUMMARY

This section provides a general summary of the disclosure, and is not a comprehensive disclosure of its full scope or all of its features.

Embodiments of the present invention provide a system for delivering an advertisement based on user characteristic information, so as to solve the problem of the prior art that the advertisement can not be delivered to particular users and the click ratio of the advertisement is low.

Embodiments of the present invention also provide a server to solve the problem of the prior art mentioned above.

Embodiments of the present invention further provide a method for delivering an advertisement based on user characteristic information, to solve the problem of the prior art mentioned above.

The technical schemes of the present invention are as follows.

A server includes:

a database, adapted to store user raw data corresponding to a client;

a characteristic mining unit, adapted to perform data mining on the user raw data to obtain user characteristic information, generate a characteristic label based on the user characteristic information, and provide the characteristic label for the advertisement delivering unit; and

an advertisement delivering unit, adapted to deliver an advertisement to the client according to the characteristic label.

A method for delivering an advertisement based on user characteristic information includes:

performing, by a server, data mining on user raw data corresponding to a client to obtain user characteristic information, generating a characteristic label based on the user characteristic information;

determining, by the server, a type of advertisement according to the characteristic label, and delivering an advertisement of the type to the client.

In the embodiments of the present invention, a great amount of user raw data are collected and stored in a server, data mining is performed on the user raw data, a characteristic label is generated based on user characteristic information obtained, and a network advertisement is delivered according to the characteristic label. Therefore, the advertisement can be delivered to particular users and the click ratio of the advertisement is increased.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustrating a structure of a system for delivering an advertisement based on user characteristic information in the prior art.

FIG. 2 is a schematic illustrating a structure of a system for delivering an advertisement based on user characteristic information in accordance with an embodiment of the present invention.

FIG. 3 is a schematic illustrating a structure of a characteristic mining unit of a system of FIG. 2.

FIG. 4 is a schematic illustrating a structure of a system for delivering an advertisement based on user characteristic information in accordance with another embodiment of the present invention.

FIG. 5 is a flow chart illustrating a method for delivering an advertisement based on user characteristic information in accordance with an embodiment of the present invention.

FIG. 6 is a flow chart illustrating a method for delivering an advertisement based on user characteristic information in accordance with another embodiment of the present invention.

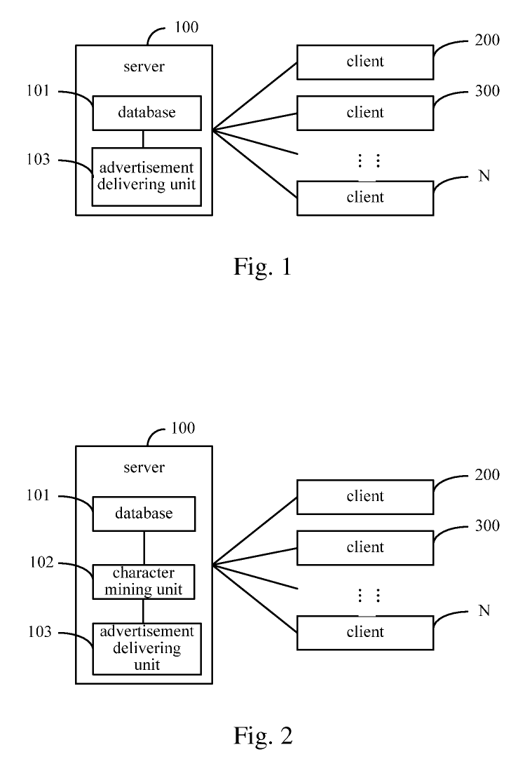

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The present invention is further explained hereinafter in detail with reference to the accompanying drawings as well as embodiments so as to make the objective, technical solution and merits thereof more apparent. It should be appreciated that the embodiments offered herein are used for explaining the present invention only and shall not be used for limiting the protection scope of the present invention.

According to embodiments of the present invention, a server collects and stores a large amount of user raw data through various channels, performs data mining on the user raw data by utilizing an established data mining model, obtains effective user characteristic information, generates a characteristic label based on the user characteristic information, and delivers a network advertisement according to the characteristic label, thus the advertisement can be delivered to particular users.

FIG. 2 illustrates a structure of a system for delivering an advertisement based on user characteristic information. The system includes a server 100, and a plurality of clients connected with the server 100, i.e. a client 200, a client 300 . . . a client N). It should be noted that the connections illustrated in all the drawings between devices are only for illustrating the information exchanging and controlling process between the devices, should be regarded as logical connections without being limited to physical connections only.

Each client, i.e. client 200, client 300 . . . client N typically is a terminal device capable of presenting an advertisement, such as a Personal Computer (PC), a Personal Digital Assistant (PDA), a Mobile Phone (MP) and so on. The protection scope of the present invention should not be limited to a specific type of clients.

The server 100 is adapted to collect and store user raw data, obtain user characteristic information from the user raw data, and deliver a network advertisement to a particular user according to the user characteristic information. The server 100 typically is a dedicated Advertisement Server (Ad Server), or a server for a large-scale website that has the functions of the Ad Server, and so on. The protection scope of the present invention should not be limited to a specific type of servers.

According to an embodiment of the present invention, the server 100 includes a database 101, a characteristic mining unit 102 and an advertisement delivering unit 103.

(1) The database 101 is adapted to store user raw data collected. There are various types of the user raw data according to embodiments of the present invention, and the user raw data can be collected through multiple approaches from various channels.

In an embodiment of the present invention, the user raw data may include: Instant Message (IM) data, website data, game data, payment data, data of scenes, advertisement clicks data and so on. The approaches for collecting the user raw data may include obtaining user registration information from websites, observing online behaviors of users in websites, and performing investigation and so on.

(2) The characteristic mining unit 102 connects with the database 101 and the advertisement delivering unit 103, and is adapted to perform data mining on the user raw data stored in the database 101, obtain user characteristic information, generate a characteristic label based on the user characteristic information, and provide the characteristic label to the advertisement delivering unit 103. The inner structure of the characteristic mining unit 102 will be described in detail in the following description.

According to embodiments of the present invention, the user characteristic information includes multiple types of information, such as personal information, household information, online behaviors, interests, and so on. In an embodiment, the user characteristic information may be illustrated in the following table.

| type of | attributes of | |
|---|---|---|
| characteristic | characteristic | Value |
| personal | age | younger than 6, 6-12, 13-15, 16-18, 19-23, |
| information | | 24-30, 31-35, 36-40, 41-50, older than 51 |
| | gender | male, female |
| | marital status | married, unmarried |
| | minority group | Han or one of 56 minority groups |
| | nationality | one of more than 100 countries |
| | province | one of the 24 provinces, 5 autonomous |
| | | regions, 4 municipalities directly under the |
| | | jurisdiction of the Central Government, and 2 |
| | | special administrative regions |
| | district | district of an administrative region |
| | education | below senior high school (technical |
| | background | secondary school), senior high school |
| | | (technical secondary school), junior college, |
| | | bachelor, master, doctor and above |
| | occupation | jobless, student, employee, worker, self- |
| | | employed, enterprise owner, peasant, |
| | | armyman, other |
| | industry | agriculture industry, forestry industry, animal |
| | | husbandry industry, fishery industry, |
| | | geological prospecting industry, water |
| | | management industry, social service industry, |
| | | real estate industry, finance industry, |
| | | insurance industry, health industry, sports |
| | | industry, social welfare industry, |
| | | manufacturing industry, wholesale and retail |
| | | commercial industry, catering industry, |
| | | education industry, cultural and art industry, |
| | | Radio, Film and TV Industry, electricity, vapor |
| | | and water production and supply industry, |
| | | transportation industry, storehouse industry, |
| | | posts and telecommunication industry, |
| | | scientific research industry, integrated |
| | | technical service industry, construction |
| | | industry, excavation industry, state organs, |
| | | parties, social organization, other industry |
| | personal monthly | 0, below 500, 501-1000, 1001-1500, 1501- |
| | income | 2000, 2001-2500, 2501-3000, 3001-4000, |
| | | 4001-5000, 5001-8000, 8001-10000, more |
| | | than 10000 |
| Household | kids | no kids, have kids |
| information | | |
| | household monthly | 0, below 1000, 1001-3000, 3001-6000, 6001- |
| | income | 8000, 8001-10000, 10001-15000, 150001- |
| | | 30000, more than 30000 |
| | number of family | 1, 2-3, more than 3 |
| | members | |
| | residential situation | owned house, rented house |
| | acreage of the house | smaller than 50, 51-100, 101-150, 151-300, |
| | | larger than 300 |
| | residential region | rural area, suburb, city |
| | main vehicles of the | none, bicycle, automobile (owned automobile, |
| | family (multiple | taxi, public traffic) |
| | choice) | |
| interest | interests (multiple | car, real estate, traveling, digital devices, |
| | choice) | music, cartoon, games, sports, friend |
| | | seeking, reading, military affairs, finance and |
| | | economics, literature, foods |
| online | location (multiple | home, work location, net bar, school, public |
| behaviors | choice) | places, others |
| | device (multiple | desktop computer, laptop computer, mobile |
| | choice) | phone |
| | access approach | dedicated Internet access, dial-up access, |
| | | broadband access |
| | time | 0-1 o'clock, 1-2 o'clock, . . . 23-24 o'clock |
| | length of time per | (hour) |
| | week | |
| | monthly costs for | (Yuan) |
| | accessing the | |
| | Internet | |
| | whether the city of | yes, no |
| | accessing the | |
| | Internet has been | |
| | changed in the past | |
| | three months | |
| | network services | browsing news, search engine, email, |
| | usually used | forum/BBS/chat group, instant messaging, |
| | (multiple choice) | information obtaining, watching/downloading |
| | | online movies/TV, listening/downloading |
| | | online music, file uploading/downloading, |
| | | online games, online schoolmates websites, |
| | | online purchasing, personal home page, blog, |
| | | online job hunting, online chat room, online |
| | | finance, e-magazine, online education, online |
| | | sales, short message/multimedia message, |
| | | VOIP, online booking, e-government, clubs |
| | | for marriage seeking/friend |
| | | seeking/community, others |

The characteristic mining unit 102 may adopt various means, such as induction, calculation, estimation, and so on, to obtain the user characteristic information shown in the above table from the user raw data stored in the database 101.

(3) The advertisement delivering unit 103 connects with the characteristic mining unit 102, and is adapted to determine the type of the advertisement to be delivered according to the characteristic label provided by the characteristic mining unit 102, and deliver an advertisement of the type to each client, i.e. client 200, client 300, . . . client N.

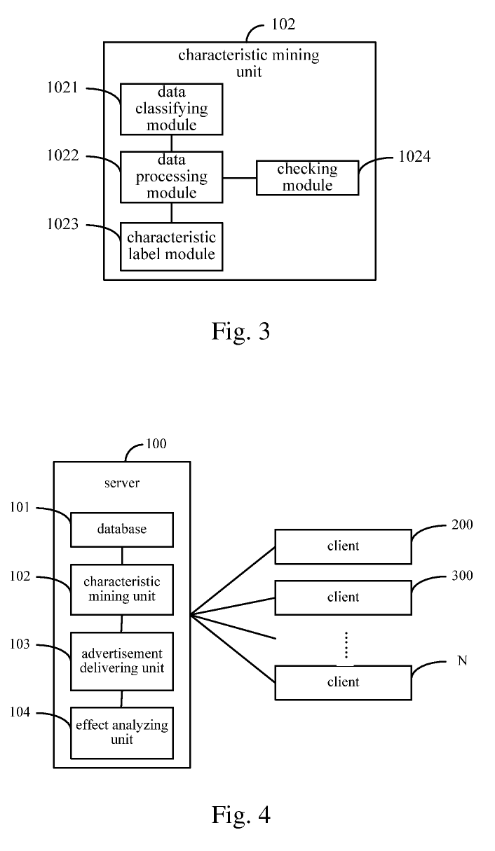

FIG. 3 illustrates an inner structure of the characteristic mining unit 102 shown in FIG. 2. The characteristic mining unit 102 includes a data classifying module 1021, a data processing module 1022, a characteristic label module 1023 and a checking module 1024.

(1) The data classifying module 1021 is adapted to classify the large amount of the user raw data stored in the database 101, i.e. classifying the users into multiple groups, and output the classified data to the data processing module 1022. This module is not required, i.e. the user raw data in the database 101 may also be directly processed by the data processing module 1022 without being classified.

(2) The data processing module 1022 is adapted to perform data mining on the user raw data in the database 101 to obtain the user characteristic information. The data processing module 1022 according to embodiments of the present invention may adopt various means to obtain the user characteristic information, such as induction, calculation, estimation, and so on, which depends on the type of the user characteristic information.

For example, user characteristic information related to interests, such as car, real estate, traveling, digital devices, music, cartoon, games, sports, friend seeking, reading, military affairs, finance and economics, literature, foods and so on, can be obtained through induction, user loyalty to a service of an enterprise, such as time of registration, frequency of use, items used, total expenditure, can be obtained through calculation; other user characteristic information can be estimated based on investigation and data filtering.

(3) The characteristic label module 1023 connects to the data processing module 1022, and is adapted to generate a characteristic label based on the user characteristic information obtained by the data processing module 1022, and output the characteristic label to the advertisement delivering unit 103.

There are multiple ways for generating the characteristic label according to embodiments of the present invention. According to a typical embodiment, the characteristic label module 1023 encodes the user characteristic information obtained, and takes the code obtained as the characteristic label.

(4) The checking module 1024 connects to the data processing module 1022, and is adapted to check the result of the data processing performed by the data processing module 1022 to improve the processing precision of the data processing module 1022. An exemplary structure of the characteristic mining unit is described above, from which the skilled person in the art should be clear that the characteristic mining unit may adopt various structures, such as one omitting the data classifying module 1021, and so on. The present invention should not be limited to a specific structure. FIG. 4 illustrates a structure of a system for delivering an advertisement based on user characteristic information in accordance with another embodiment of the present invention. The system includes a server 100 and multiple clients connecting to the server 100, i.e. client 200, client 300, . . . client N. Different from the structure shown in FIG. 2, the server 100 of FIG. 4 includes an effect analyzing unit 104 besides the database 101, the characteristic mining unit 102 and the advertisement delivering unit 103.

The effect analyzing unit 104 is adapted to analyze the effect of the advertisement delivery based on response of each client, i.e. client 200, client 300, . . . client N, such as calculate exposure rate, hit ratio, i.e. clicks rate, and so on, and provide data obtained to the characteristic mining unit 102 for determining the effect of the data mining and for optimizing the performances.

According to embodiments of the present invention, calculation of the exposure rate and hit ratio may adopt multiple ways. In an embodiment, the effect analyzing unit 104 may employ the following formula for calculating the exposure rate: exposure rate=number of users receiving the delivered advertisement/total number of users; and the effect analyzing unit 104 may employ the following formula for calculating the hit ratio: hit ratio=number of clicks/number of exposure.

In the above embodiment, the exposure rate and hit ratio obtained may be as shown in the following table:

| user | number | name of | number of | exposure | number | |
|---|---|---|---|---|---|---|
| category | of users | advertisement | exposure | rate | of clicks | hit ratio |
| car fan | 1 million | BMW S series | 900 thousand | 90% | 300 thousand | 33.3% |
| female user | 5 million | Lux soap | 3 million | 60% | 2.4 million | 80% |

In the above embodiment, the exposure rate and hit ratio obtained may be as shown in the following table:

| | | | number | | | |
|---|---|---|---|---|---|---|
| | number | name of | of | exposure | number | |
| user category | of users | advertisement | exposure | rate | of clicks | hit ratio |
| male white- | 1 million | Advertisement | 400 | 40% | 100 | 25% |
| collars aged | | of | thousand | | thousand | |
| 25-30 in | | “South | | | | |
| Shenzhen city | | Mountain” | | | | |
| | | estate | | | | |
| females aged | 500 | new | 400 | 80% | 300 | 75% |
| above 30 | thousand | arrival | thousand | | thousand | |
| whose | | garment | | | | |
| household | | | | | | |
| income is over | | | | | | |
| 500 thousand | | | | | | |

In this embodiment, the effect analyzing unit 104 may adopt other means for calculating the exposure rate and the hit ratio of an advertisement, so the protection scope should not be limited to the methods mentioned above.

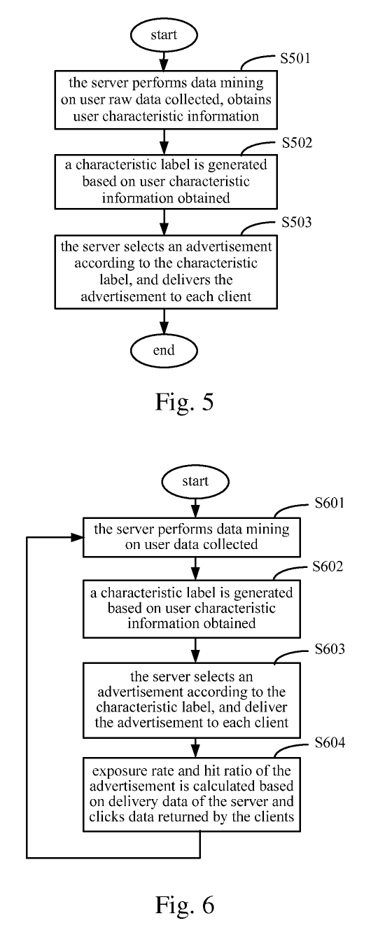

FIG. 5 is a flow chart illustrating a method for delivering an advertisement based on user characteristic information. The method is based on the system structures shown in FIGS. 2 to 4, and includes steps as follows. Before starting the process of the embodiments of the present embodiment, the server 100 may collect user raw data through various approaches or channels, and store the user raw data into the database 101. The user raw data may include IM data, website data, game data, payment data, scenario data, clicks data of advertisements and so on. The user raw data may be collected by obtaining user registration information from a website, by observing online behaviors of users in websites, or by performing investigation and so on.

In step S501, the server 100 performs data mining on the user raw data collected and obtains user characteristic information from the user raw data. There may be various types of user characteristic information according to the embodiments of the present invention, such as personal information, household information, online behaviors, interests, and so on, which may be as shown in the table of the embodiment above illustrated in FIG. 2. In this step, the characteristic mining unit 102 in the server 100 may obtain the user characteristic information from the user raw data stored in the database 101. Different approaches may be adopted for different types of user characteristic information, such as induction, calculation, estimation and so on.

For example, user characteristic information related to interests, such as car, real estate, traveling, digital devices, music, cartoon, games, sports, friend seeking, reading, military affairs, finance and economics, literature, foods and so on, can be obtained through induction, user loyalty to a service of an enterprise, such as time of registration, frequency of use, items used, total expenditure, can be obtained through calculation; other user characteristic information can be estimated based on investigation and data filtering.

In addition, in step S501 may first classify the user raw data, and then obtain the user characteristic information from the classified user raw data.

In step S502, the server 100 generates a characteristic label based on the user characteristic information obtained. In this step, various means can be adopted for generating the characteristic label. In a typical embodiment, the characteristic label module 1023 may generate the characteristic label by encoding the user characteristic information obtained by the data processing module 1022 and taking the code obtained as the characteristic label.

In step S503, the server 100 selects an advertisement to be delivered according to the characteristic label, and deliver the advertisement selected to each client, i.e. client 200, client 300 . . . client N.

As described in the above, the characteristic label may include user characteristic information, such as personal information, household information, online behaviors, interests of the user and so on, thus the advertisement delivering unit 103 of the server 100 may select a particular advertisement to be delivered based on the above user characteristic information, and deliver the advertisement.

FIG. 6 is a flow chart illustrating another method for delivering an advertisement based on user characteristic information. The method is based on the system structure shown in FIG. 4, and includes steps as follows.

Before the steps of the present embodiment, the server 100 may collect user raw data through various channels or approaches, and store the user raw data into the database 101. The user raw data may include IM data, website data, game data, payment data, scenario data, clicks data of advertisements, and so on. The user raw data may be collected by obtaining user registration information from a website, by observing online behaviors of users in websites, or by performing investigation, and so on.

In step S601, the server 100 performs data mining on the user raw data collected and obtains user characteristic information from the user raw data. Details of this step are the same with that of the step S501.

In step S602, the server 100 generates a characteristic label based on the user characteristic information obtained. In this step, various means may be adopted for generating the characteristic label, and details of this step are the same with that of the step S502.

In step S603, the server 100 selects an advertisement to be delivered according to the characteristic label, and deliver the advertisement selected to each client, i.e. client 200, client 300 . . . client N, and details of this step are the same with that of the step S503.

In step S604, exposure rate and hit ratio of the advertisement delivered can be calculated based on delivery data of the server 100 and clicks data returned by each client i.e. client 200, client 300, client N, and the results of the calculation can be provided t the characteristic mining unit 102. Then step S601 is performed again. In this way, the process of data mining can be optimized by utilizing the exposure rate and the hit ratio.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A server for delivering an advertisement based on user characteristic information, comprising:
a database, adapted to store user raw data corresponding to a client;
a characteristic mining unit, adapted to perform data mining on the user raw data to obtain user characteristic information, generate a characteristic label based on the user characteristic information, and provide the characteristic label for the advertisement delivering unit; and
an advertisement delivering unit, adapted to deliver an advertisement to the client according to the characteristic label.

2. The server of claim 1, wherein the characteristic mining unit comprises:
a data processing module, adapted to perform the data mining on the user raw data to obtain the user characteristic information; and
a characteristic label module, adapted to generate the characteristic label based on the user characteristic information.

3. The server of claim 2, wherein the characteristic mining unit further comprises:
a data classifying module, adapted to classify the user raw data, and provide the classified user raw data to the data processing module.

4. The server of claim 3, wherein the characteristic mining unit further comprises:
a checking module, adapted to check a data processing result of the data processing module to improve processing precision of the data processing module.

5. The server of claim 3, wherein the server further comprises:
an effect analyzing unit, adapted to analyze effect of the advertisement delivery based on response of the client, and provide a result of the analyzing to the characteristic mining unit; and
the characteristic mining unit is further adapted to select user characteristic information which satisfies a pre-set delivery condition based on the result of the analyzing.

6. The server of claim 4, wherein the server further comprises:
an effect analyzing unit, adapted to analyze effect of the advertisement delivery based on response of the client, and provide a result of the analyzing to the characteristic mining unit; wherein
the characteristic mining unit is further adapted to select user characteristic information which satisfies a pre-set delivery condition based on the result of the analyzing.

7. The system of claim 6, wherein
the result of the analyzing comprises exposure rate or clicks ratio.

8. A system for delivering advertisements based on user characteristic information, comprising a client and a server as described in claim 1.

9. A method for delivering an advertisement based on user characteristic information, comprising:
performing, by a server, data mining on user raw data corresponding to a client to obtain user characteristic information, generating a characteristic label based on the user characteristic information;
determining, by the server, a type of advertisement according to the characteristic label, and delivering an advertisement of the type to the client.

10. The method of claim 9, further comprising: collecting, by the server, the user raw data, and storing the user raw data to a database;
wherein the user raw data comprises: Instant Messaging data, website data, game data, payment data, scenario data and clicks data of an advertisement.

11. The method of claim 9, wherein generating the characteristic label based on the user characteristic information comprises: encoding the user characteristic information, and taking a result of the encoding as the characteristic label.

12. The method of claim 9, wherein the user characteristic information comprises at least one of personal information, household information, online behaviors and interests.

13. The method of claim 9, further comprising:
receiving, by the server, a response about the advertisement to the server;
analyzing, by the server, effect of the advertisement delivery based on the response about the advertisement from the client;
selecting, by the server, user characteristic information which satisfies a pre-set delivery condition based on a result of the analyzing.
